(19) United States
(12) Patent Application Publication
(10) Pub. No.: US 2011/0155513 A1
(43) Pub. Date: Jun. 30, 2011

(54) ELEVATOR DOOR

(76) Inventor: Peter A. Spiess, Meggen (CH)

(21) Appl. No.: 12/976,142

(22) Filed: Dec. 22, 2010

(30) Foreign Application Priority Data
Dec. 22, 2009 (EP) 09180486.4

(51) Int. Cl. B66B 13/30; B66B 13/08

(52) U.S. Cl. 187/340

(57) ABSTRACT

An elevator door includes a fast panel and one or more successively slower panels, wherein each panel has a front surface, a parallel rear surface and a lagging surface interconnecting the front surface and rear surface. The lagging surface of a successively faster panel is accommodated between the front surface and the rear surface of a successively slower panel when the door is in its fully open position. With this arrangement, the panels can be accommodated one inside the other when the door is in its fully open position and consequently the depth of the telescopic door can be reduced significantly.

### FIELD OF THE INVENTION

The present invention relates to elevator doors and, in particular, to elevator doors having a plurality of horizontally-sliding panels and a synchronisation mechanism to control simultaneous movement of the panels.

### BACKGROUND OF THE INVENTION

In a conventional elevator a one or more telescopic doors are used to to close and open a opening in a shaft wall. The door is generally composed of a plurality of identical panels supported via rollers on one or more overhead tracks. Each panel is connected to a cable and pulley system located above the door to endure synchronous movement of panels.

### SUMMARY OF THE INVENTION

An objective of the present invention is to reduce the material involved in the manufacture of telescopic elevator doors and thereby the associated cost of elevator doors. Accordingly, the invention provides an elevator door comprising a fast panel and one or more successively slower panels, wherein each panel has a front surface, a parallel rear surface and a lagging surface interconnecting the front surface and rear surface. The lagging surface of a successively faster panel is accommodated between the front surface and the rear surface of a successively slower panel when the door is in its fully open position. With this arrangement, the panels can be accommodated one inside the other when the door is in its fully open position and consequently the depth of the telescopic door can be reduced significantly.

The invention is particularly useful for the modernization of existing elevator installations having a swing door at the landing since the depth of the swing door is significantly smaller than that of a conventional telescopic elevator door.

Preferably, the front surface, the parallel rear surface and the lagging surface of the or each slower panel forms a J-shaped profile.

Preferably, the panels are fabricated from sheet metal.

The elevator door may include a first synchronous linkage mechanism incorporated within a depth of the door as defined by the front surface and rear surface of the slowest panel.

More preferably, the first synchronous linkage mechanism comprises a series of links extending alternatively upwards and downwards between a first pivot point mounted to a door frame and a further pivot point mounted to the fast panel. Each successively slower panel is pivotally mounted to intermediate pivot points on intermediate links of the synchronous linkage mechanism.

The elevator door can further comprise a second synchronous linkage mechanism wherein the second synchronous linkage mechanism is identical to the first synchronous linkage mechanism but vertically displaced thereform and further comprising a bar to interconnect corresponding points on both linkage mechanisms.

### DESCRIPTION OF THE DRAWINGS

The present invention is hereinafter described by way of specific examples with reference to the accompanying drawings in which:

FIG. 1 is a horizontal cross-section of an elevator shaft;

FIG. 2A is a cross-sectional view of an elevator door according to a first embodiment of the present invention in its fully open;

FIG. 2B illustrates the door of FIG. 2A in a fully closed position;

FIG. 3 is a cross-sectional view of the telescopic landing door of FIG. 1 incorporating a synchronous linkage mechanism according to the invention;

FIG. 4 is a schematic of the telescopic landing door of FIG. 3 in its closed position; and

FIG. 5 shows the landing door of FIG. 4 as it opens.

### DESCRIPTION OF THE PREFERRED EMBODIMENT

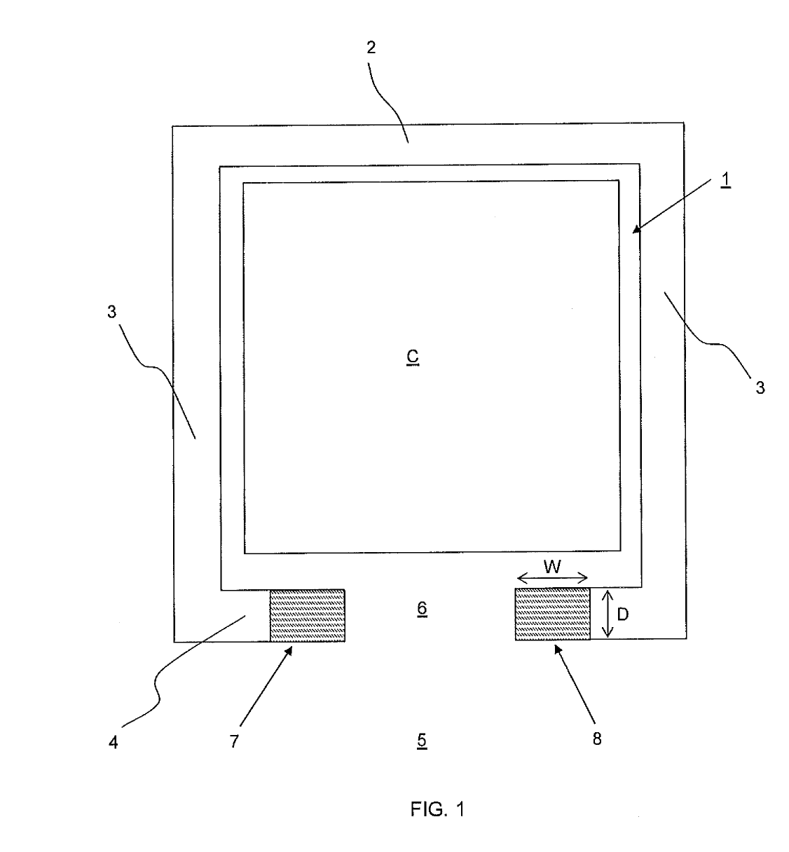

FIG. 1 shows a horizontal cross-section of an elevator shaft 1 arranged within a building. The shaft 1 is bound by a rear wall 2, two side walls 3 and a front wall 4. An elevator car C is arranged to travel vertically within the shaft 1. At each floor or landing 5 of the building an opening 6 is provided in the front wall 4 of the shaft 1 to enable passengers to migrate between the elevator car and the landing 5. Two telescopic doors 7 and 8 are arranged to the left and to the right of the opening 6 respectively to close laterally across the opening 6 and thereby prevent entry to the shaft 1 when the car is not present at a specific landing 5. In the open position as shown, each of the telescopic doors 7 and 8 have a width W and a depth D which corresponds substantially to the depth of the front wall 4 of the shaft 1.

To avoid unnecessary repetition, the following description concentrates almost exclusively on the telescopic door 7 arranged to the left of the opening 6. However, it will be appreciated that both doors 7 and 8 are symmetrical with and mirror images of each other.

To facilitate the interchange of the description between the doors 7 and 8, instead of describing a component as being to the left or right, the term “leading” has been used extensively to describe a component that is foremost in the lateral closing direction of the door 7 or 8 and conversely the term “lagging” to describe a component that is hindmost in the closing direction. The front and rear transverse directions are common to both doors 7 and 8.

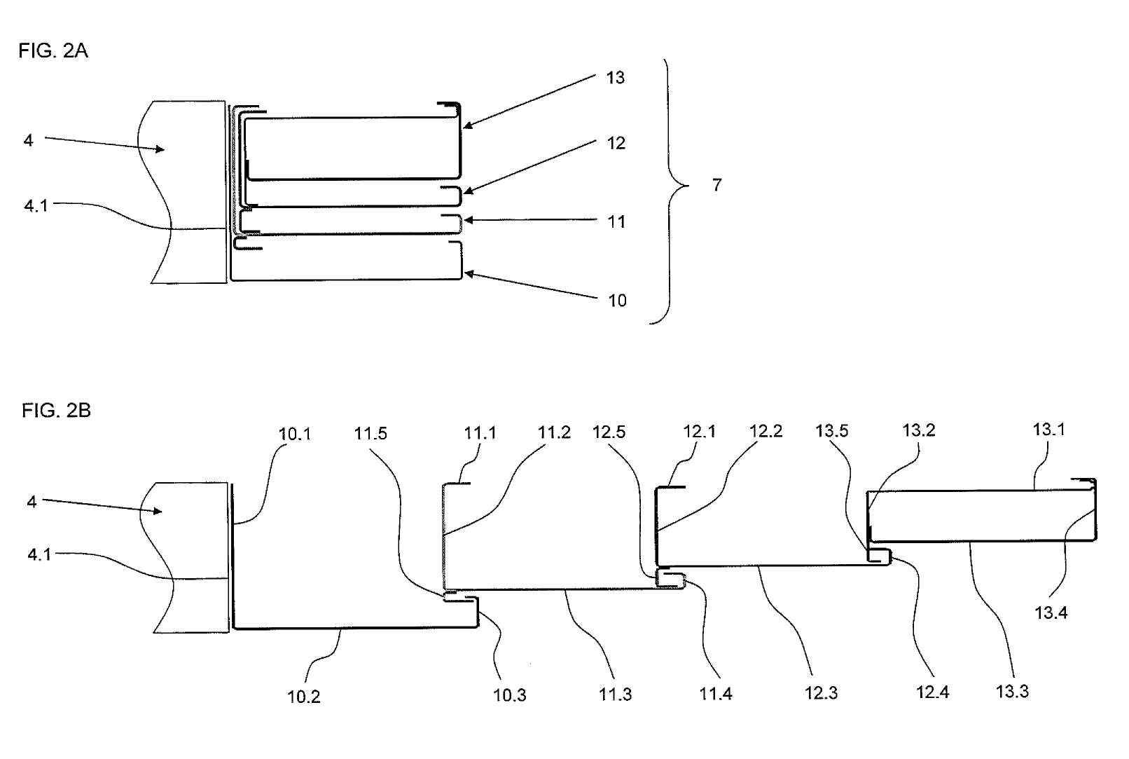

FIG. 2A is a cross-sectional view of the telescopic landing door 7 of FIG. 1 and illustrates in particular the arrangement of the associated door panels 11, 12 and 13 in their stacked or stored position so as to permit passenger to pass through the opening 6 in the shaft wall 4.

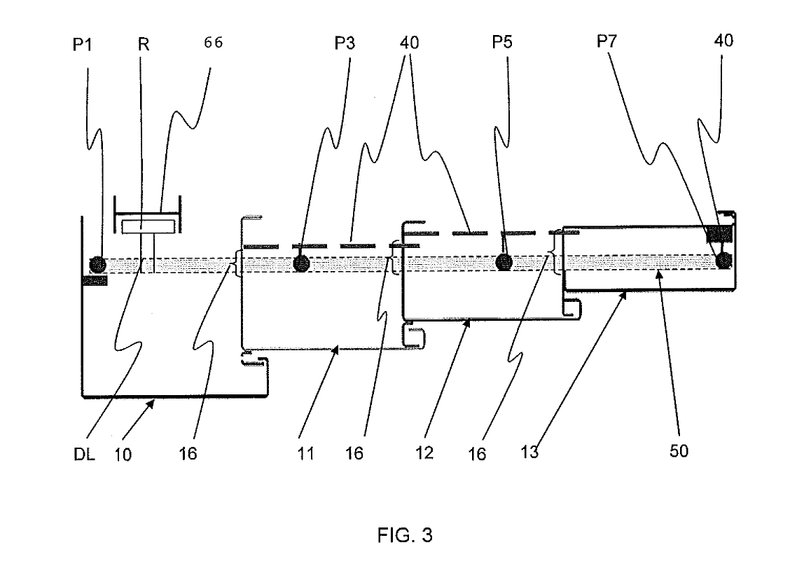

In closing, although all of the panels 11, 12, and 13 move laterally across the opening 6 in the shaft wall 4 at the same time, they travel at different but proportional speeds so that the fast panel 13 travels furthest across the opening 6 and is trailed successively by the intermediate panel 12 and the slow panel 11, respectively. This movement of the panels 11, 12 and 13 is achieved by a synchronous linkage mechanism 50 which will be described later with reference to FIGS. 3-5.

In the fully closed position, as shown in FIG. 2B, a leading surface 13.4 of the fast panel 13 meets the leading surface of the corresponding fast panel from the other door 8 at the center of the opening 6.

In addition to the panels 11, 12 and 13, the door 7 further comprises a stationary door frame or post 10. The post 10 is manufactured from sheet metal and has a generally L-shaped profile. The transverse limb 10.1 of the post 10 is attached in conventional manner to an edge 4.1 of the front wall 4 of the shaft 1. The lateral limb forms the front surface 10.2 of the post 10 and effectively shields the panels 11, 12 and 13 from the landing 5 when the door 7 is in the open position as shown in FIG. 2A. A double-fold 10.3 at the free, leading edge of the front surface 10.2 provides a channel to the rear of the front surface 10.2.

The slow panel 11 is manufactured from sheet metal and has a generally angular, J-shaped profile comprising a lateral rear surface 11.1, a parallel front surface 11.3 and an interconnecting, transverse, lagging surface 11.2. As with the post 10, a double-fold 11.4 is provided at the leading edge of the front surface 11.3. A vertical channel 11.5 is mounted at the lagging edge of the front surface 11.3 and projects forwards therefrom. The channel 11.5 has a transposed configuration to the double-fold 10.3 of the door post 10 so that with the door 7 in the fully closed position, as shown specifically in FIG. 2B, the double-fold 10.3 of the door post 10 is at least partially accommodated within the channel 11.5 of the slow door panel 11. This arrangement not only prevents a person on the landing 5 from prying the post 10 and the slow panel 11 apart but also prevents the slow panel 11 from over-travelling as the door 7 closes. Additionally, the channel 11.5 also provides added stiffness and rigidity to the panel 11.

As the intermediate panel 12 is essentially identical to the slow panel 11, further specific description of the intermediate panel 12 is superfluous. However, one important exception is that the depth of the intermediate panel 12, as defined by the transverse, lagging surface 12.2, is smaller than the corresponding depth of the slow panel 11. Again, a vertical channel 12.5 on the intermediate panel 12 has a transposed configuration to the double-fold 11.4 of the slow panel 11 so that with the door 7 in the fully closed position the double-fold 11.4 of the slow panel 11 is at least partially accommodated within the channel 12.5 mounted on the intermediate panel 11.

The fast panel 13 has a different construction to the other door panels 11 and 12 primarily because, during use, larger forces are exerted on the fast panel 13. For example, if an obstacle is present in the opening 6 during a closing operation, then any impact force would have to be transmitted through or absorbed by the leading, fast panel 13 rather than the other panels 11 and 12. Furthermore, as explained further on in the description with respect to FIG. 8, the weight of the other panels 11 and 12 is partially transmitted through the fast panel 13. The fast panel 13 is manufactured from sheet metal to provide a closed, rectangular profile having a lateral rear surface 13.1, a transverse lagging surface 13.2, a lateral front surface 13.3 and a transverse leading surface 13.4. The lagging surface 13.2 extends forward from the front surface 13.3 and is folded to form a vertical channel 13.5. This channel 13.5 has a transposed configuration to the double-fold 12.4 of the intermediate panel 12 so that with the door 7 in the fully closed position the double-fold 12.4 of the intermediate panel 12 is at least partially accommodated within the channel 13.5 of the fast panel 13.

As can be seen clearly from the figures, when progressing from the slow panel 11 to the intermediate panel 12 to the fast panel 13, the depth of the panels, as defined by the transverse lagging surfaces 11.2, 12.2 and 13.2, is sequentially reduced. The consequence of this arrangement is that in the fully opened position, as shown in FIG. 2A, the intermediate panel 12 and the fast panel 13 are fully accommodated between the planes of the rear surface 11.1 and the front surface 11.3 of the slow panel 11.

Since the panels are manufactured from sheet metal, the provision of rear surfaces 11.1 and 12.1 on the slow and intermediate panels 11 and 12 is essential to provide sufficient mechanical strength and rigidity to the front surfaces 11.3 and 12.3 of the panels.

FIG. 3 is a cross-sectional view of the telescopic landing door 7 of FIG. 1 incorporating a synchronous linkage mechanism 50 according to the invention. A hole 16 is punched through the transverse, lagging surface 11.2, 12.2 and 13.2 of each of the panels 11, 12 and 13 to accommodate the linkage 50 extending from the door post 10 to the fast panel 13. The linkage 50 is pivotally mounted to each of the panels 11, 12 and 13 by means of a bracket mechanism 40.

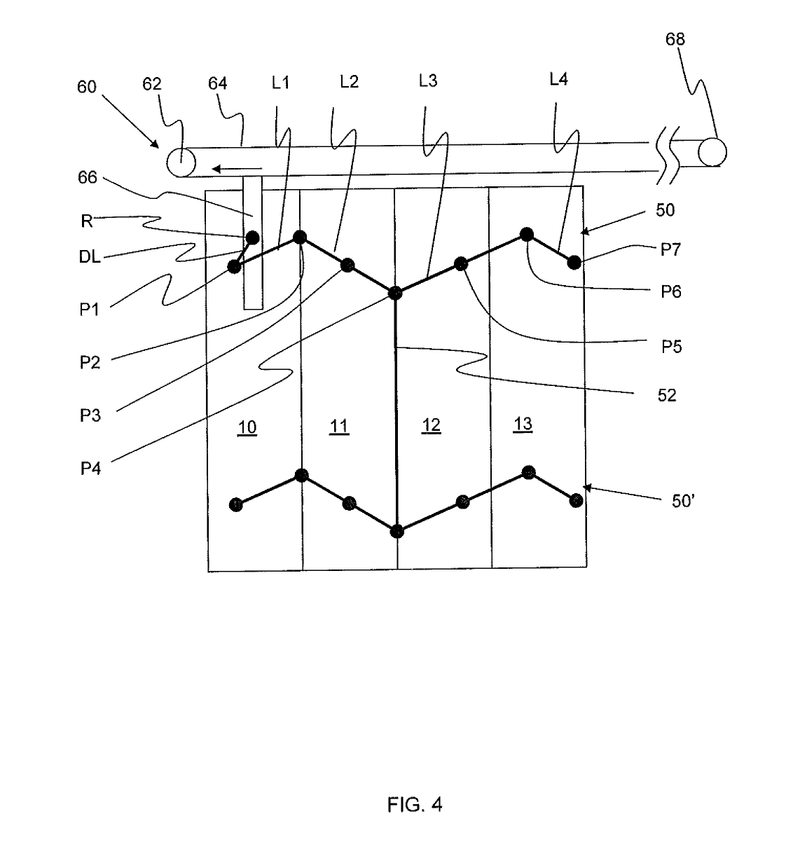

As show in greater detail in FIG. 4, the synchronous linkage mechanism 50 comprises a series of links L1, L2, L3 and L4 which extend alternatively upwards and downwards between a first pivot point P1 mounted to the door frame 10 and a seventh pivot point P7 mounted to the fast panel 13. The first link L1 extends upwards from the first pivot point P1 and is connected at its end to the second link L2 at pivot point P2. The second link L2 extends downwards from the second pivot point P2 and is connected at its end to the third link L3 at the fourth pivot point P4. The third link L3 extends upwards from the fourth pivot point P4 and is connected at its end to the fourth link L4 at the sixth pivot point P6. The slow panel 11 is pivotally mounted to the linkage 50 at an intermediate point P3 on the second link L2. Similarly the intermediate panel 12 is pivotally mounted to the linkage 50 at an intermediate point P5 on the third link L3.

A second identical synchronous linkage mechanism 50′ is provided below the first linkage 50 and a rigid bar 52 interconnects corresponding pivot points P4 on both linkages 50 and 50′.

A drive lever DL is pivotally attached to the first pivot point P1 so as to rotate concurrently with the first link L1 about the first pivot point P1. As shown in FIG. 3, the drive lever DL extends outwards from the synchronous linkage mechanism 50′ and into the elevator shaft 1. A roller R is mounted to the end of the drive lever DL.

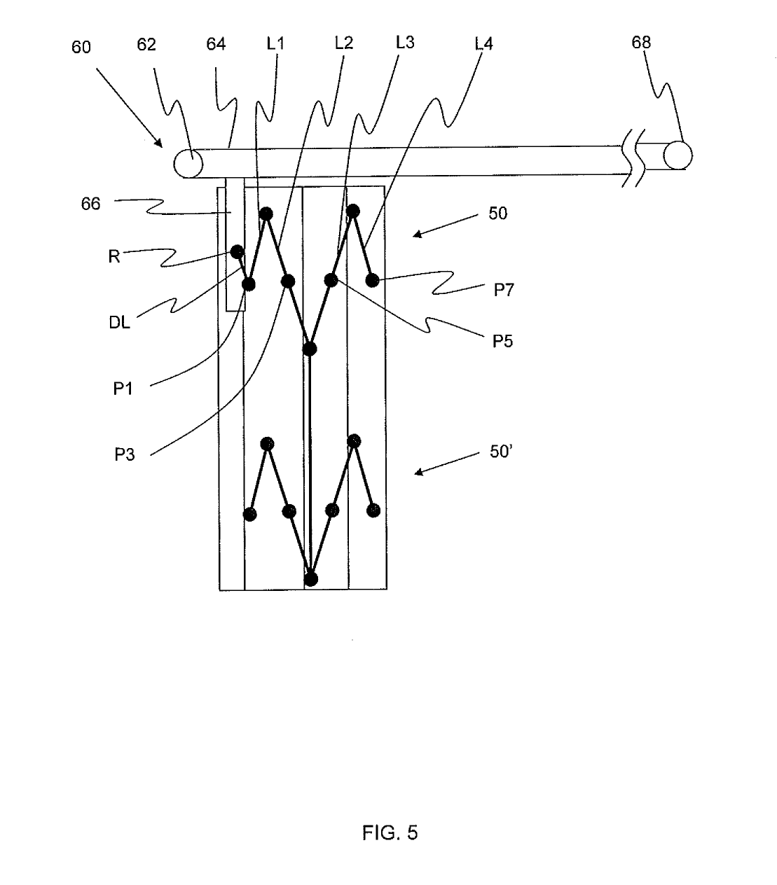

The landing door 7 is driven by a drive 60 mounted on the elevator car C. The drive 60 comprises a motor 62 to drive a closed-loop toothed belt 64 which subscribes a path between the motor 62 at one side and a return pulley 68 at the other side of the opening 6. A vertically aligned H-beam 66 is attached to the toothed belt 64 for concurrent horizontal movement therewith. As shown in FIG. 4, when the elevator car is level with the closed landing door 7, the roller R mounted to the end of the drive lever DL is accommodated in a channel defined by the H-beam 66. As the motor 60 and toothed belt 62 move the H-beam 66 to the left, as indicated by the arrow, the drive lever DL rotates counter-clockwise concurrently with the first link L1 about the first pivot point P1. This rotation of the first link L1 causes simultaneous rotation of the remaining links L2, L3 and L4 about pivot points P3, P5 and P7 respectively and the landing door 7 opens as shown in FIG. 5.

The skilled person will readily appreciate that a similar synchronous linkage mechanism 50 can be applied to the elevator car door in which case the roller of the drive lever of the car door linkage can be accommodated in the opposing channel of the H-beam 66 as shown in FIG. 3.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator door including a fast panel and at least one slower panel, wherein the fast panel moves faster than the at least one slower panel during opening and closing of the door and wherein each panel has a front surface, a parallel rear surface and a lagging surface interconnecting the front surface and rear surface, comprising:
the lagging surface of the fast panel is accommodated between the front surface and the rear surface of the at least one slower panel when the door is in a fully open position.

2. The elevator door according to claim 1 wherein the front surface, the parallel rear surface and the lagging surface of the at least one slower panel form a J-shaped profile.

3. The elevator door according to claim 1 wherein the panels are fabricated from sheet metal.

4. The elevator door according to claim 1 further including a first synchronous linkage mechanism incorporated within a depth of the door between the front surface and the rear surface of a slowest panel of the door.

5. The elevator door according to claim 4 wherein the first synchronous linkage mechanism includes a series of links extending alternatively upwards and downwards between a first pivot point mounted to a door frame for the door and a further pivot point mounted to the fast panel.

6. The elevator door according to claim 5 wherein the at least one successively slower panel is pivotally mounted to an intermediate pivot point on an intermediate link of the first synchronous linkage mechanism.

7. The elevator door according to claim 4 further including a second synchronous linkage mechanism wherein the second synchronous linkage mechanism is identical to the first synchronous linkage mechanism but vertically displaced therefrom and further comprising a bar interconnecting corresponding points on the first and second linkage mechanisms.

8. An elevator door comprising:
a fast panel;
an intermediate panel that moves slower than the fast panel during opening and closing of the door; and
a slow panel that moves slower than the intermediate panel during opening and closing of the door, wherein each of the panels has a front surface, a parallel rear surface and a lagging surface interconnecting the front surface and rear surface, the lagging surfaces of the fast panel and the intermediate panel being accommodated between the front surface and the rear surface of the slow panel when the door is in a fully open position.

9. The elevator door according to claim 8 wherein the front surface, the parallel rear surface and the lagging surface of the intermediate panel and the slow panel form a J-shaped profile.

10. The elevator door according to claim 8 wherein the panels are fabricated from sheet metal.

11. The elevator door according to claim 8 further including a first synchronous linkage mechanism incorporated within a depth of the door between the front surface and the rear surface of the slow panel of the door.

12. The elevator door according to claim 11 wherein the first synchronous linkage mechanism includes a series of links extending alternatively upwards and downwards between a first pivot point mounted to a door frame for the door and a further pivot point mounted to the fast panel.

13. The elevator door according to claim 12 wherein the intermediate panel and the slow panel each are pivotally mounted to intermediate pivot points on intermediate links of the first synchronous linkage mechanism.

14. The elevator door according to claim 11 further including a second synchronous linkage mechanism wherein the second synchronous linkage mechanism is identical to the first synchronous linkage mechanism but vertically displaced therefrom and further comprising a bar interconnecting corresponding points on the first and second linkage mechanisms.
